(19) United States
(12) Patent Application Publication
(10) Pub. No.: US 2002/0124610 A1
(43) Pub. Date: Sep. 12, 2002

(54) Lock assembly and a method for operating a lock mechanism

(76) Inventor: Alan Robert Harwood, Hayes (GB)

Correspondence Address: QUARLES & BRADY LLP, 411 E. WISCONSIN AVENUE, SUITE 2040, MILWAUKEE, WI, 53202-4497, US

(21) Appl. No.: 10/039,813

(22) Filed: Oct. 26, 2001

(30) Foreign Application Priority Data
Oct. 27, 2000 (GB) GB 0026282.4

(51) Int. Cl. E05B 49/00

(52) U.S. Cl. 70/278.3

(57) ABSTRACT

A barrel lock assembly 1 comprises a tubular housing 2 formed with a longitudinal access slot 4 extending through the wall of the housing 2; an inner barrel section 6 formed with an array of locking pins 8 extending upwardly from an array of slits 10; an electrically driven actuator 12 comprising a solenoid 14 and an actuating bar 16. In the assembled state (as shown in FIG. 2) the bar 16 is received by the access slot 4. The inner barrel 6 has extending from one end thereof a square peg section 18. A catch member 20 is fitted onto the square peg section 18. At the opposite end of the inner barrel there is a disc-like section 22 formed with a keyhole slot 24. Extending radially from the section 22 is a handle 26.

The electrically driven actuator 12 is operated by sending an electrical signal to the solenoid 14 via a wire 27. When the solenoid 14 is activated the bar 16 is forced downwardly in a direction towards the locking pins 8. The bar 16 pushes the locking pins 8 radially inwardly away from the access slot 4.

The present invention relates to a lock assembly and a method for operating a lock mechanism and the invention also relates to a rack unit for securing electrical equipment comprising a plurality of lock assemblies.

Barrel lock assemblies are widely used. Known barrel lock assemblies comprise an outer housing within which there is an inner rotatable barrel that in turn contains a row of retractable pins. When the barrel lock is in the locked condition the pins extend radially beyond the barrel. The distal ends of the pins are received by a slot formed in the outer housing whereby the inner barrel is prevented from rotating. When a correct key is inserted into the inner barrel the pins retract away from the slot and into the body of the barrel. The inner barrel can then be rotated.

According to a first aspect of the present invention there is provided a barrel lock assembly comprising an inner barrel within which there is an array of locking pins, and an electrically activated actuator, the arrangement being such that the actuator is operative to disengage the locking pins such that the inner barrel can rotate.

Preferably, the barrel lock assembly comprises a barrel lock housing formed with an access slot, the inner barrel being contained in the housing and distal ends of the array of locking pins being received by the slot when the lock assembly is in the locked condition, the arrangement being such that the actuator is operative to disengage the locking pins from the access slot such that the inner barrel can rotate within the housing.

The electrically activated actuator preferably comprises a bar, the arrangement being such that in use the actuator moves the bar into the slot formed in the housing and into contact with the pins and the actuator further moves the bar through the slot such that the pins are removed from the slot.

The bar preferably extends parallel to the central axis of the barrel and movable transversely to the axis of the barrel.

The electrically activated actuator is preferably an electrical solenoid.

Alternatively, the electrically activated actuator is an electric motor assembly.

The electric motor assembly preferably comprises a cam unit the arrangement being such that in use the cam unit is used to disengage the locking pins from the access slot such that the inner barrel can rotate within the housing.

According to a second aspect of the present invention there is provided a method for operating a lock mechanism, the method comprises electrically energising an actuator, moving a portion of the actuator against a pin array of a barrel lock and disengaging the pins so allowing the lock to open.

According to a third aspect of the present invention there is provided a method for remotely unlocking a barrel lock mechanism, the method comprising remotely energising an actuator such that a portion of the actuator is moved against an array of pins of a barrel lock and disengaging the pins so allowing the lock to be rotated.

According to a fourth aspect of the present invention there is provided a security system for electrical equipment rack units comprising a plurality of compartments for holding electrical equipment, each compartment being secured by a lock assembly according to the first aspect of the present invention and control means operative to unlock and lock one or more of the lock assemblies.

The security system preferably comprises a master key that may unlock one or more of the individual lock assemblies.

The security system preferably comprises a control unit for operating the network of lock assemblies. The control unit may be used to unlock individual compartments.

Preferably, the security system comprises means to identify individual user and allow access to the appropriate compartments of the individual user.

In use the rack units comprising a plurality of compartments may contain electrical equipment belonging to different individuals and it will be desirable to limit the access to specific compartments. The use of the means to identify individual user allows access to the appropriate compartments to be limited.

There are particular advantages to combining the features of the various aspects of the present invention and the invention may include any combination of the features or limitations referred to herein.

The present invention may be carried into practice in various ways and some embodiments will now be described, by way of example only, with reference to the accompanying drawings in which:

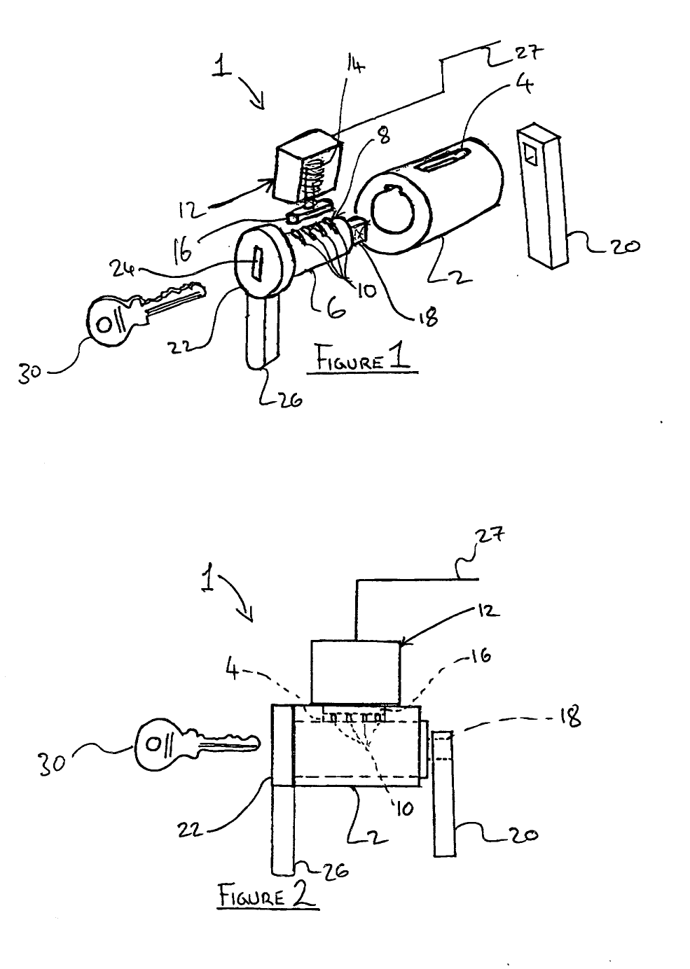

FIG. 1 is an exploded isometric view of a disassembled barrel lock and electrically driven actuator according to the first aspect of the present invention,

FIG. 2 is a side view of the assembled barrel lock and electrically driven actuator shown in FIG. 1, and

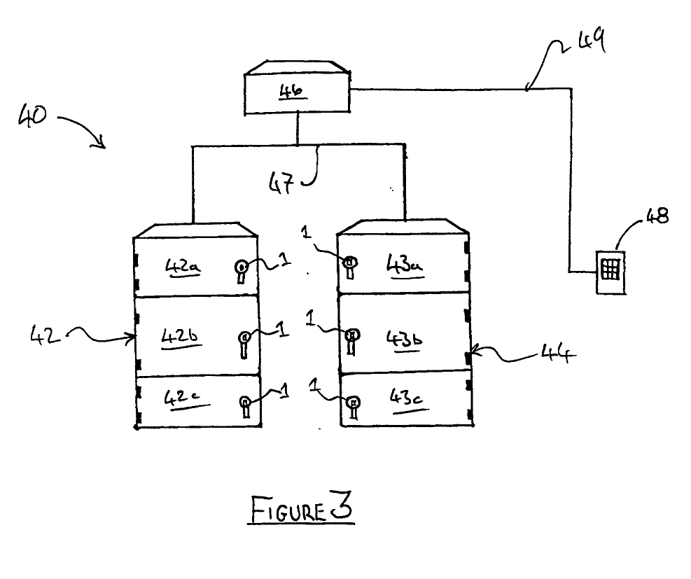

FIG. 3 is a schematic view of a security system for electrical equipment rack units comprising a plurality of compartments for holding electrical equipment and a network of lock assemblies according to the first aspect of the present invention;

With reference to the FIGS. 1 and 2, a barrel lock assembly 1 comprises a tubular housing 2 formed with a longitudinal access slot 4 extending through the wall of the housing 2; an inner barrel section 6 formed with an array of locking pins 8 extending upwardly from an array of slits 10; an electrically driven actuator 12 comprising a solenoid 14 and an actuating bar 16. In the assembled state (as shown in FIG. 2) the bar 16 is received by the access slot 4. The inner barrel 6 has extending from one end thereof a square peg section 18. A catch member 20 is fitted onto the square peg section 18. At the opposite end of the inner barrel there is a disc-like section 22 formed with a keyhole slot 24. Extending radially from the section 22 is a handle 26.

The electrically driven actuator 12 is operated by sending an electrical signal to the solenoid 14 via a wire 27. When the solenoid 14 is activated the bar 16 is forced downwardly in a direction towards the locking pins 8. The bar 16 pushes the locking pins 8 radially inwardly away from the access slot 4. When the locking pins 8 are distant from the access slot 4 the inner barrel 6 can be rotated about its central longitudinal axis. The barrel lock assembly 1 is then in the unlocked condition.

The present invention allows a standard barrel lock assembly to be unlocked remotely using an electrical signal and an electrically driven actuator. The skilled person is the art will appreciate that any suitable electrical actuator can be used. For example an electrical motor connected to a suitable camming assembly can be used to provide the downward force required to depress the locking pins 8.

A plurality of barrel lock assemblies 1 may be provided each having a respective electrically driven actuator. The plurality of barrel lock assemblies may be provided with one master key 30. The master key 30 may be used to unlock all the barrel lock assemblies.

With reference to FIG. 3, a security system 40 for holding electrical equipment comprises two rack units 42, 44, a network of lock assemblies 1, as previously described, providing locking means for the respective compartments, a control unit 46 for operating the network of lock assemblies 1, and security identification means 48.

Rack unit 42 comprises three compartments 42a, 42b, 42c. Rack unit 43 comprises three compartments 43a, 43b, 43c.

The control unit 46 is connected to the lock assemblies 1 by wiring network 47. The security identification means 48 is connected to the control unit 46 by wire 49.

In use the security identification means 48 would allow access to a predetermined number of the compartments 42a, 42b, 42c, 43a, 43b, 43c. The user would key in an identification number into the unit 48 and the control unit 46 would unlock the predetermined compartments. The security system would allow the individual to access only the compartments for which they have authorisation. A master key 30 could be provided to allow access to all of the compartments. Separate individual keys could also be provided to the individual users to allow them to access their compartments in the circumstances where there was an electrical fault. Any number of racks and compartments may be provided. The control unit may be pre-programmed to allow an individual access to a predetermined number of compartments to allow him to access his electrical equipment.

1. A barrel lock assembly (1) comprising an inner barrel (6) within which there is an array of locking pins (10), and an electrically activated actuator (12), the arrangement being such that the actuator (12) is operative to disengage the locking pins (10) such that the inner barrel (6) can rotate.

2. A barrel lock assembly as claimed in claim 1, wherein the barrel lock assembly (1) comprises a barrel lock housing (2) formed with an access slot (4), the inner barrel (6) being contained in the barrel lock housing (2) and distal ends of the array of locking pins (10) being receivable by the slot (6) when the lock assembly (1) is in the locked condition, the arrangement being such that the actuator (12) is operative to disengage the array of locking pins (10) from the access slot (4) such that the inner barrel (6) can rotate within the housing (2).

3. A barrel lock assembly as claimed in claim 2, wherein the electrically activated actuator (12) comprises a bar (16), the arrangement being such that in use the actuator (12) moves the bar (16) into the slot (4) formed in the housing (2) and into contact with the pins (10) and the actuator (12) further moves the bar (16) through the slot (4) such that the pins (10) are removed from the slot (4).

4. A barrel lock assembly as claimed in claim 3 wherein the bar (16) extends parallel to the central axis of the barrel (6) and being movable transversely to the axis of the barrel (6).

5. A barrel lock assembly as claimed in any one of claims 1 to 4 wherein the electrically activated actuator (12) is an electrical solenoid.

6. A barrel lock assembly as claimed in any one of claims 1 to 4 wherein the electrically activated actuator (12) is an electric motor assembly.

7. A barrel lock assembly as claimed in claim 6 wherein the electric motor assembly comprises a cam unit the arrangement being such that in use the cam unit is used to disengage the locking pins (10) from the access slot (4) such that the inner barrel (6) can rotate within the housing (2).

8. A method for operating a lock mechanism (1), the method comprises electrically energising an actuator (16), moving a portion of the actuator against a pin array (10) of a barrel lock and disengaging the pins (10) so allowing the lock to open.

9. A method for remotely unlocking a barrel lock mechanism (1), the method comprising remotely energising an actuator (12) such that a portion (16) of the actuator (12) is moved against an array of pins (10) of a barrel lock (6) and disengaging the pins (10) so allowing the lock to be rotated.

10. A security system (40) for electrical equipment rack units comprising a plurality of compartments for holding electrical equipment, each compartment being secured by a lock assembly (1) as claimed in any one of claims 1 to 7 and control means operative to unlock and lock one or more of the lock assemblies (7).

11. A security system (40) as claimed in claim 10 wherein the security system comprises a master key that may unlock one or more of the individual lock assemblies.

12. A security system as claimed in claim 10 or claim 11 wherein the security system (40) comprises a control unit (46) for operating the network of lock assemblies.

13. A security system as claimed in any one of claims 10 to 12 wherein the security system comprises means to identify an individual user and allow access to the appropriate compartments of the individual user.

14. A security system as claimed in any one of claims 10 to 13 wherein the rack units comprise a plurality of compartments containing electrical equipment belonging to different individuals and provides limited access to specific compartments.
